(19) United States
(12) Patent Application Publication
(10) Pub. No.: US 2026/0370474 A1
(43) Pub. Date: Nov. 19, 2026

(54) USER DEVICE INTERACTION FOR DIRECT TRANSFER

(71) Applicant: Visa International Service Association, San Francisco, CA (US)

(72) Inventors: Salvador Ricardo, Miami, FL (US); Cristina Villarroel, Miami, FL (US); Ricardo Collada, Miami, FL (US); Jenny Ramirez, Miami, FL (US); Daniel Villar, Miami, FL (US); Manuel Ferreiro Caballero, Miami, FL (US); Maikel Zuniga, Miami, FL (US); Liset Iturriaga Chavez, Miami, FL (US)

(73) Assignee: Visa International Service Association, San Francisco, CA (US)

(21) Appl. No.: 19/490,694

(22) PCT Filed: Jun. 13, 2024
(86) PCT No.: PCT/US2024/033818

§ 371 Date: Dec. 5, 2025

Related U.S. Application Data
(60) Provisional application No. 63/509,132, filed on Jun. 20, 2023.

(51) Int. Cl. H04L 9/32

(52) U.S. Cl. CPC H04L 9/3213

(57) ABSTRACT

A method is disclosed and includes receiving, by a server computer from an interaction application on a sender user device, an interaction request message comprising a sender credential identifier, a receiver credential and a value for an interaction between a sender operating the sender user device and a receiver. The receiver credential is associated with the receiver and received by the interaction application after the receiver interacts a portable device comprising the receiver credential with the sender user device. The method includes transmitting, to a token service computer, a token request message comprising the sender credential identifier, and then receiving, from the token service computer, a token response message comprising a sender token. The method includes transmitting, to a gateway computer, the sender token, the receiver credential, and the value. The gateway computer then processes the interaction using the value, the receiver credential, and the sender token.

### CROSS-REFERENCE TO RELATED APPLICATIONS

This is a PCT application, which claims priority to U.S. Provisional Application No. 63/509,132 filed on Jun. 20, 2023, which is herein incorporated by reference in its entirety.

### BACKGROUND

Interactions may involve a sending user interacting with a receiving user. The sending user can initiate the interaction by operating a sender user device. As an example, the sending user may use an interaction application on the sender user device to send funds to the receiving user. The interaction can be processed by a processing network, a first authorizing entity associated with the sender user, and a second authorizing entity associated with the receiving user.

Methods and systems for conducting an interaction between users (e.g., a sender user operates a user device to send funds to a receiving user) generally involve two user devices and utilize an excess of computing resources, as they involve both a sender user device and a receiver user device. Moreover, these methods may be inconvenient, as extra steps may be required to ensure that both users have an interaction application downloaded to their respective user devices.

While it is possible to use a single user device to conduct an interaction between a sender and a receiver, this may require that the sender use a credential, which may be sensitive information. There is a risk that the credential could be obtained by a man-in-the-middle during the transmission of the credential through a data network, or by a hacker if the credential is stored within computers in the data network or if the credential is stored within a sender user device.

Embodiments of the invention address these and other problems, individually and collectively.

### BRIEF SUMMARY

Embodiments are directed towards methods for using a user device (e.g., mobile phone) and a portable device (e.g., an access card or payment card) to initiate an interaction between a sender user and a receiver user.

One embodiment of the invention includes a method comprising: receiving, by a server computer from an interaction application on a sender user device, an interaction request message comprising a sender credential identifier, a receiver credential and a value for an interaction between a sender operating the sender user device and a receiver, the receiver credential associated with the receiver and received by the interaction application after the receiver interacts a portable device comprising the receiver credential with the sender user device; transmitting, by the server computer to a token service computer, a token request message comprising the sender credential identifier; receiving, by the server computer from the token service computer, a token response message comprising a sender token; and transmitting, by the server computer to a gateway computer, the sender token, the receiver credential, and the value, wherein the gateway computer processes the interaction using the value, the receiver credential, and the sender token.

Another embodiment of the invention can include a server computer comprising a processor, and a computer readable medium. The computer readable medium comprises code, executable by the processor, to perform a method comprising: receiving, from an interaction application on a sender user device, an interaction request message comprising a sender credential identifier, a receiver credential and a value for an interaction between a sender operating the sender user device and a receiver, the receiver credential associated with the receiver and received by the interaction application after the receiver interacts a portable device comprising the receiver credential with the sender user device; transmitting, to a token service computer, a token request message comprising the sender credential identifier; receiving, from the token service computer, a token response message comprising a sender token; and transmitting, to a gateway computer, the sender token, the receiver credential, and the value, wherein the gateway computer processes the interaction using the value, the receiver credential, and the sender token.

Another embodiment of the invention can include a method comprising: interacting, a portable device comprising a receiver credential with a sender user device in an interaction between a sender operating the sender user device and a receiver, the receiver credential associated with the receiver; transmitting, by an interaction application on the sender user device to a server computer, an interaction request message comprising the receiver credential, a sender credential identifier, and a value for the interaction, wherein the server computer transmits a token request message comprising the sender credential identifier to a token service computer and receives from the token service computer, a token response message comprising a sender token, and transmits the sender token, the receiver credential, and the value to a gateway computer, wherein the gateway computer processes the interaction using the sender token, the receiver token, and the value; and receiving, by the sender user device an interaction response message from the server computer for the interaction.

Another embodiment of the invention can include a sender user device comprising a processor, and a computer readable medium. The computer readable medium comprises code, executable by the processor, to perform a method as described above.

These and other embodiments are described in further detail below.

### Terms

Prior to discussing specific embodiments of the invention, some terms may be described in detail.

A “user” may include an individual. In some embodiments, a user may be associated with one or more personal accounts and/or mobile devices. The user may also be referred to as a cardholder, account holder, or consumer.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “portable device” may comprise any suitable electronic device that may be operated by a user. In some embodiments, a portable device may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of portable devices include cards, mobile phones (e.g., cellular phones), PDAs, tablet computers, net books, laptop computers, personal music players, handheld specialized readers, wearable devices, as well as automobiles with remote communication capabilities.

A “user identifier” can include any piece of data that can identify a user. A user identifier can comprise any suitable alphanumeric string of characters. In some embodiments, the user identifier may be derived from user identifying information. In some embodiments, a user identifier can include an account identifier associated with the user. For example, a user can be associated with an account, which has an account identifier, maintained by an authorizing entity computer.

A “credential” may be any suitable information that serves as reliable evidence of worth, ownership, identity, or authority. A credential may be a string of numbers, letters, or any other suitable characters that may be present or contained in any object or document that can serve as confirmation.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction can include a transaction interaction, a data transfer interaction, an access interaction, etc.

An “interaction request message” may be an electronic message that requests authorization for an interaction. In some embodiments, it is sent to a gateway computer and/or an authorizing entity computer associated with a portable device to request authorization for an interaction involving the portable device. The interaction request message may be a pull interaction message or a push interaction message. The interaction request message may include an authorizing entity account identifier that may be associated with a portable device or account. An interaction request message may also comprise interaction information associated with a current interaction, such as a value for the interaction, and a credential. An interaction request message according to some embodiments may be an authorization request message.

“Interaction data” can include data related to and/or recorded during an interaction. In some embodiments, interaction data can include an amount, a date, a time, one or more user identifiers, credentials, and/or additional data relating to an interaction between a sender user and receiver user.

An “interaction response message” may be a message that responds to an interaction request. In some cases, it may be an electronic message reply to an interaction request message. The interaction response message may include, by way of example only, one or more of the following status indicators: Approval—interaction was approved; Decline—interaction was not approved.

An “interaction application” may be code or other data stored on a computer readable medium (e.g. memory element or secure element) that may be executable by a processor to initiate an interaction.

A “pull interaction message” may be an interaction request message seeking that a value of a current interaction be debited from an account. The pull interaction message can comprise one or more indicators that enable an authorizing entity to make an authorization decision regarding the account that it manages. In embodiments, the pull interaction message may be used to debit the value for the interaction from an account associated with the sender, and can comprise a sender credential and the value for the interaction. An example of a pull transaction message can include an AFT message.

An AFT (Account Funding Transaction) is a transaction designed to supply funds to another account such as a credit, prepaid, debit, ATM or online account. In some cases, an AFT is paying the service provider bank for sending funds to the recipient and results in a debit to the sender's card account.

A “push interaction message” may be an interaction request message seeking that a value of a current interaction be credited to an account. The push interaction message can comprise one or more indicators that enable an authorizing entity to deliver a value for the interaction to a recipient account that it manages. The transmission of a push interaction message may be separate from and can take place after the transmission of a pull interaction message. An example of a push transaction message can be a credit transaction message such as an OCT message.

A “credit transaction message” may include a message that initiates a credit to an account. In some embodiments, the credit transaction message may be an Original Credit Transaction (OCT) message. An OCT (Original Credit Transaction) is typically a clearing and settlement credit transaction designed for use in business applications such as a business money transfer or business-to-consumer repayments. When used in embodiments of the present invention, the OCT transaction can be used to deliver funds to the target account. In some cases, It is separate from, and in some cases, can takes place after, an AFT transaction.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue account credentials stored on a user device, such as a cellular telephone, smart card, tablet, or laptop to the user.

A “computing device” may include any suitable device that can electronically process data. Examples of computing devices include desktop computers, mobile devices or mobile computing devices, television sets, etc.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

A “token” may be a substitute value for a credential. A token may be a string of numbers, letters, or any other suitable characters. Examples of tokens include tokens, access tokens, personal identification tokens, etc. A token may include an identifier for an account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, an account identifier (e.g., a primary account number (PAN)) may be tokenized by replacing the primary account identifier with a substitute number (e.g., a token) that may be associated with the account identifier. Further, tokenization may be applied to any other information that may be replaced with a substitute value. Tokenization may be used to enhance transaction efficiency, improve transaction security, increase service transparency, or to provide a method for third-party enablement.

A “tokenization request message” may be an electronic message for requesting that data is replaced with substitute data. For example, a credential can be tokenized and replaced with a credential identifier.

A “token provider” or “token service computer” can include one or more computers that service tokens. In some embodiments, a token service computer can facilitate requesting, determining (e.g., generating) and/or issuing tokens, as well as maintaining an established mapping of tokens to primary account numbers (PANs) in a repository (e.g., token vault). In some embodiments, the token service computer may establish a token assurance level for a given token to indicate the confidence level of the token to PAN binding. The token service computer may include or be in communication with a token vault where the generated tokens are stored. The token service computer may support token processing of transactions submitted using tokens by de-tokenizing the token to obtain the actual PAN and conducting a transaction using that PAN. In some embodiments, a token service computer may include a tokenization computer alone, or in combination with other computers such as a transaction processing network computer. Various entities of a tokenization ecosystem may assume the roles of the token provider. For example, processing networks and issuers or their agents may become the token provider by implementing the token services according to embodiments of the present invention.

A “token request message” may be an electronic message for requesting a token. A token request message may include information usable for identifying a payment account or digital wallet, and/or information for generating a payment token. For example, a token request message may include payment credentials, mobile communication device identification information (e.g. a phone number or MSISDN), a digital wallet identifier, information identifying a tokenization service provider, a merchant identifier, a cryptogram, and/or any other suitable information. Information included in a token request message can be encrypted (e.g., with an issuer-specific key). In some embodiments, the token request message may include a flag or other indicator specifying that the message is a token request message.

A “token response message” may be a message that responds to a token request. A token response message may include an indication that a token request was approved or denied. A token response message may also include a payment token, mobile communication device identification information (e.g. a phone number or MSISDN), a digital wallet identifier, information identifying a tokenization service provider, a merchant identifier, a cryptogram, and/or any other suitable information. Information included in a token response message can be encrypted (e.g., with an issuer-specific key). In some embodiments, the token response message may include a flag or other indicator specifying that the message is a token response message.

A “detokenization request message” may include any message that requests de-tokenization of a token from a processor associated with the token. For example, a de-tokenization request message may be sent by a system (e.g., a server computer) to de-tokenize a token when the system does not have access to the tokenization algorithm or tokenization scheme of the processor or otherwise does not recognize the token. In such cases, the system may request the token be de-tokenized such that the underlying credential may be determined.

A “detokenization response message” may include any message that is sent in response to the de-tokenization request message. For example, the de-tokenization response message may include the credential associated with the token that was included in the de-tokenization request message. Additionally, if a processor does not recognize or cannot otherwise determine credential associated with the payment token, the de-tokenization response message may include an error message, unknown token message, or other information to inform a system that the token cannot be de-tokenized.

A “gateway” may refer to an electronic system used to accept, transmit, or process interactions made by user devices and portable devices. The gateway may transfer information and funds among authorization entities (e.g., issuers) and users.

### BRIEF DESCRIPTION OF THE DRAWINGS

FIG. 1 shows a block diagram of a system according to an embodiment.

FIG. 2 shows a block diagram of a server computer according to an embodiment.

FIG. 3 shows a block diagram of a token service computer according to an embodiment.

FIG. 4 shows a block diagram of a user device according to an embodiment.

FIG. 5 shows a diagram of a portable device according to an embodiment.

FIG. 6 shows a flow diagram of a tokenization process according to an embodiment.

FIG. 7 shows a flow diagram of a method for using a user device and a portable device to initiate an interaction between a sender user and a receiver user.

FIG. 8 illustrates an example communication flow between a portable device and a user device according to some embodiments.

### DETAILED DESCRIPTION

Embodiments of the disclosure enable an interaction between a sender user and a receiver user to be conducted from a sender user device. Embodiments can use short range communication protocol (e.g., NFC) capability of a user device to capture credentials from portable devices (e.g., payment card). Embodiments can also tokenize credentials to obtain tokens. The tokens, and other interaction details such as a value for the interaction, can be transmitted to a gateway and the gateway can process the interaction.

The conversion of credentials to tokens can protect the credentials during interactions since the credentials are not exposed or used during many initial steps in interaction processing. Moreover, tokens can be limited use, and only valid for a specific kind of interaction (e.g., e-commerce, card not present). If a token is obtained by a malicious third party, it does not compromise the credential. A new token can be provisioned for the credential rather than creating a new account with a new credential.

Prior to an interaction, a sender user may enroll an account with an interaction application (e.g., a digital wallet application) downloaded to the sender's user device. The interaction application can obtain a sender user credential, which may be captured (e.g., using NFC) from a portable device associated with the sender user's account. The interaction application can transmit the sender user credential to a token service computer via a server computer, and the token service computer can determine a sender user token and a sender credential identifier. The token service computer can store the sender credential identifier with the sender user token and the sender user credential. The token service computer can transmit the sender credential identifier to the interaction application on the sender user device via the server computer, and the interaction application can store the sender credential identifier. The interaction application can use the sender credential identifier, instead of the sender token or sender credential, in future interactions.

The sender credential identifier may be an identifier for the credential, but not the credential itself. The sender credential identifier may also be in a format that is incapable of being used to process access transactions such as payment transactions. For example, if a credential is the number 4000 0001 0002 00003, then a credential identifier may be a different format such as X182382. The credential identifier cannot be used to conduct an interaction. If it is stolen by a hacker or a man-in-the-middle, it cannot be used to conduct unauthorized interactions or transactions.

In embodiments of the invention, the sender user may enroll a plurality of accounts with an interaction application. Each account can be associated with a unique credential identifier and credential. When the sender user initiates an interaction, the sender user can select an enrolled account to use for the interaction by selecting a credential identifier. The user can input interaction details such as a value for the interaction into the interaction application on the sender user device. The interaction application may prompt to interact a portable device of the receiver user with the sender user device. During the interaction of the portable device with the sender user device, the sender user device can capture a receiver credential from the portable device. The sender user device can transmit to a server computer the receiver credential, the value for the interaction, and the sender credential identifier associated with the enrolled account selected by the sender user in an interaction request message. After receiving the interaction request message from the sender user device, the server computer can obtain the sender token from the token service computer. The server computer can then transmit the sender token, the value for the interaction, and the receiver credential to a gateway computer to further process the interaction.

The further processing of the interaction can comprise reformatting interaction information, generating push and pull interaction messages, and forwarding them to appropriate authorizing entity computers for authorization and processing.

Prior to an interaction, a second authorizing entity, which may store a receiver credential and manage an account on behalf of the receiver user, may provide a receiver user profile comprising the receiver credential to a gateway computer. In some embodiments, the receiver credential can be a primary account number issued by the second authorizing entity operating the second authorizing entity computer. The primary account number may have a portion (e.g., a BIN or bank identification number) which identifies the second authorizing entity computer. Similarly, a first authorizing entity, which may manage an account on behalf of the sender user, may provide a sender user profile comprising the sender credential to the gateway computer. Because the first authorizing entity and second authorizing entity seeded the gateway with the profiles of the sender user and receiver user, the gateway can route the interaction information to the first authorizing entity and the second authorizing entity to complete interactions conducted between the sender user and the receiver user. In some embodiments, the first authorizing entity can debit the sender account and the second authorizing entity can credit the receiver account for a transaction amount for a transaction to transfer the amount from the sender user to the receiver user.

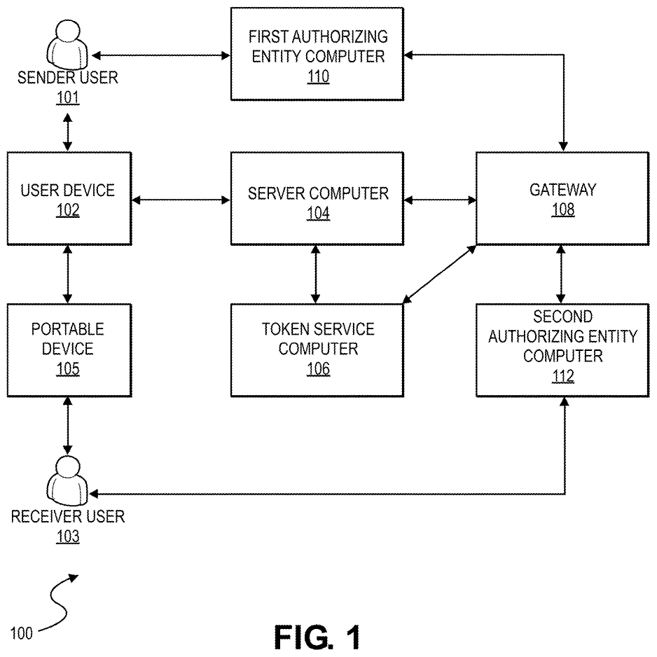

FIG. 1 shows a block diagram of a system according to embodiments. A sender user 101 may interact a sender user device 102 with a portable device 105 in order to conduct an interaction (e.g., payment) with receiver user 103. The portable device 105 may be a card associated with an account belonging to receiver user 103. The sender user device 102 may have an interaction application installed which communicates with the server computer 104. The interaction application may serve as an interface for the sender user 101 to input interaction details such as a value for the interaction, and a receiver credential. In some embodiments, the interaction application may be a digital wallet application or a value transfer application (e.g., a money transfer application).

When the receiver user 103 interacts with receiver user's portable device 105 with the sender user device 102, the sender user device 102 may receive a receiver credential. In some cases, the sender user device 102 can receive the receiver credential from the receiver user's portable device 105 via a short range contactless communication protocol such as NFC (near field communications). The interaction application on the sender user device 102 can communicate with the server computer 104 and send an interaction request message comprising a sender credential identifier to initiate an interaction. In turn, the server computer 104 can communicate with a token service computer 106 to obtain a sender token for the interaction using the sender credential identifier. The server computer 104 may also be in operable communication with a gateway computer 108. The server computer 104 can transmit messages to the gateway computer 108 so that the gateway computer 108 can process the interaction accordingly.

The system of FIG. 1 further comprises a first authorizing entity computer 110 that may manage an account on behalf of the sender user 101 and a second authorizing entity computer 112 that may manage an account on behalf of the receiver user 103. The gateway computer 108 can be in operable communication with a plurality of authorizing entity computers including first authorizing entity computer 110 and second authorizing entity computer 112.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between the devices in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network that may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

Before an interaction is conducted between a sender user and a receiver user, the first authorizing entity computer 110 and the second authorizing entity computer 112 can provide profile data of the sender user and the receiver user to the gateway computer 108. For example, the first authorizing entity computer 110 can provide a sender user profile comprising the sender credential, and the second authorizing entity computer 112 can provide a receiver user profile comprising the receiver credential. The gateway computer 108 can store a plurality of user profiles, wherein each profile can comprise a credential, the authorizing entity that manages the account associated with the credential, and optionally other user identifiers such as a user name.

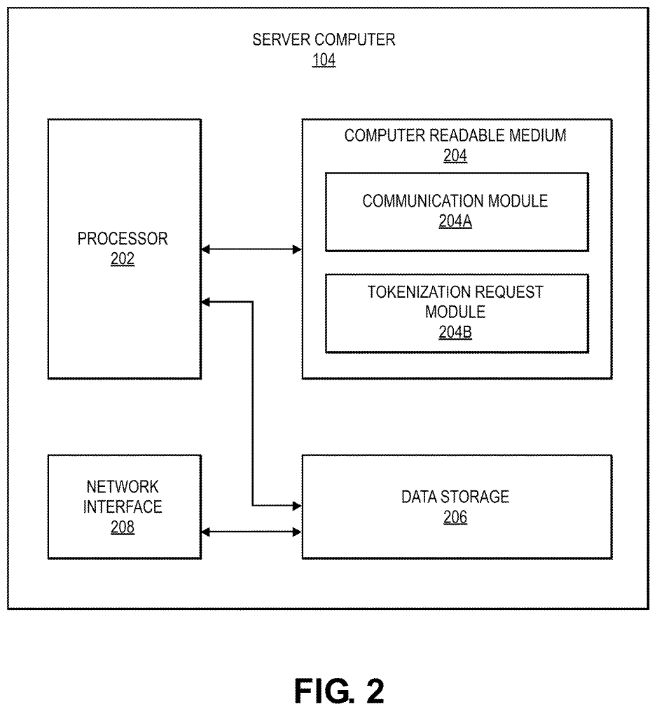

FIG. 2 illustrates a block diagram of a server computer 104 according to embodiments. The server computer 104 may be associated with an interaction application on the sender user device 102, and may be an application server computer. The server computer 104 may comprise a processor 202, which may be coupled to a computer readable medium 204, data storage 206, and a network interface 208. The data storage 206 may contain access data such as credential identifiers, tokens and/or credentials, as well as mappings between the access data and communication device identifiers such as phone numbers, IP addresses, etc.

The computer readable medium 204 may comprise a number of software modules including a communication module 204A, and a tokenization request module.

The communication module 204A may comprise code that causes the processor 202 to generate, forward, reformat, and receive messages, and/or otherwise communicate with other entities. For example, the communication module 204A can comprise code that enables the processor 202 to receive interaction request messages from the sender user device 102 and transmit access data and interaction values to the gateway computer 108. In another example, the communication module 204A can enable the processor 202 to forward interaction response messages from the gateway computer 108 to the sender user device 102.

The tokenization request module 204B can comprise code that causes the processor 202 to generate and transmit tokenization request messages and token request messages. For example, when the server computer 104 receives an interaction request message from the sender user device 102 comprising a sender credential identifier, code in the tokenization request module 204B may cause the processor 202 to request that the token service computer 106 determine a token based on the sender credential identifier.

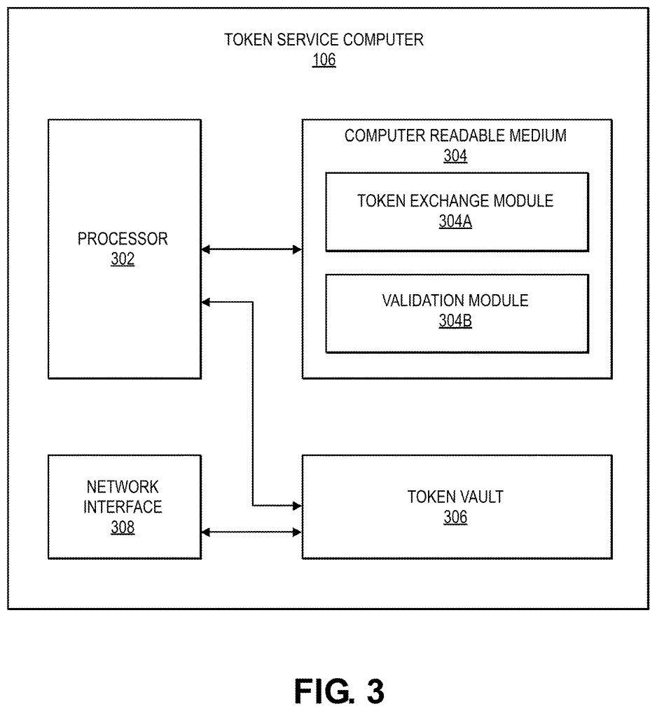

FIG. 3 shows a token service computer 106. The token service computer 106 includes a processor 302 and a computer readable medium 304, a token vault 306, and a network interface 308 coupled to the processor 302.

The computer readable medium 504 may comprise a token exchange module 304A and a validation module 304B.

The token vault 306 may store tokens and their associated credentials in a database. The token vault 306 may store data in a database such as an Oracle™ database. For example, the token service computer 106 can store profiles and any associated tokens in the token vault 306.

The token exchange module 304A may comprise code that causes the processor 302 to provide interaction tokens. For example, the token exchange module 304A may contain logic that causes the processor 302 to generate or obtain a token and/or associate the token with a credential and/or a credential identifier.

The validation module 304B may comprise code that causes the processor 302 to validate token requests, tokenization requests, de-tokenization requests, and the like. For example, validation module 304B may contain logic that causes the processor 302 to confirm that a de-tokenization request message is valid by verifying a cryptogram (e.g., with a cryptographic key) in the de-tokenization request message. If the cryptogram is not valid, then the de-tokenization request message may be declined.

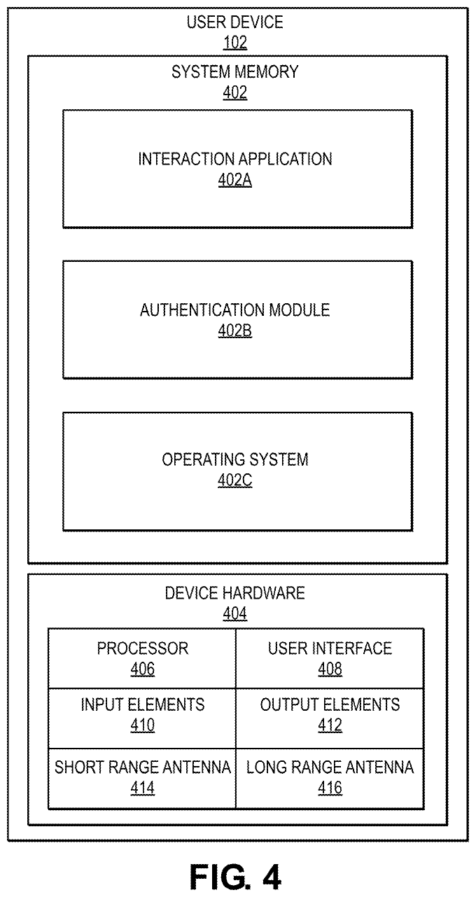

FIG. 4 illustrates a diagram of a sender user device 102 according to an embodiment. Sender user device 102 may include device hardware 404 coupled to a system memory 402.

Device hardware 404 may include a processor 406, a short range antenna 414, a long range antenna 416, input elements 410, a user interface 408, and output elements 412 (which may be part of the user interface 408). Examples of input elements may include microphones, keypads, touchscreens, sensors, etc. Examples of output elements may include speakers, display screens, and tactile devices. The processor 406 can be implemented as one or more integrated circuits (e.g., one or more single core or multicore microprocessors and/or microcontrollers), and is used to control the operation of mobile communication device 400. The processor 406 can execute a variety of programs in response to program code or computer-readable code stored in the system memory 402, and can maintain multiple concurrently executing programs or processes.

The long range antenna 416 may include one or more RF transceivers and/or connectors that can be used by sender user device 102 to communicate with other devices and/or to connect with external networks. The long range antenna 416 may be configured to communicate with a remote base station and a remote cellular or data network, over the air. The short range antenna 409 may be configured to communicate with external entities through a short range communication medium. The short range antenna 409 may comprise a contactless interface that can interact with a contactless interface of another device (e.g., a portable device). Examples of a contactless interface may include one or more radio frequency (RF) transceivers that can send and receive communications using near-field communications (NFC), or other radio frequency or wireless communication protocols. The user interface 408 can include any combination of input and output elements to allow a user to interact with and invoke the functionalities of sender user device 102.

The system memory 402 can be implemented using any combination of any number of non-volatile memories (e.g., flash memory) and volatile memories (e.g. DRAM, SRAM), or any other non-transitory storage medium, or a combination thereof media. The system memory 402 may store computer code, executable by the processor 406, for performing any of the functions described herein. For example, the system memory 402 may comprise a computer readable medium comprising code, executable by the processor 406, for implementing a method comprising: interacting, a portable device comprising a receiver credential with a sender user device in an interaction between a sender operating the sender user device and a receiver, the receiver credential associated with the receiver; transmitting, by an interaction application on the sender user device to a server computer, an interaction request message comprising the receiver credential, a sender credential identifier, and a value for the interaction, wherein the server computer transmits a token request message comprising the sender credential identifier to a token service computer and receives from the token service computer, a token response message comprising a sender token, and transmits the sender token, the receiver credential, and the value to a gateway computer, wherein the gateway computer processes the interaction using the sender token, the receiver credential, and the value; and receiving, by the sender user device an interaction response message from the server computer for the interaction

The system memory 402 may also store an interaction application 402A, an authentication module 402B, and an operating system 402C. The interaction application 402A may include instructions or code executable by the processor 406 for initiating and conducting an interaction with an external device such as a portable device 105, and for transmitting interaction request messages to the server computer 104. The authentication module 402B may comprise code, executable by the processor 406, to authenticate a user. This can be performed using user secrets (e.g., passwords) or user biometrics.

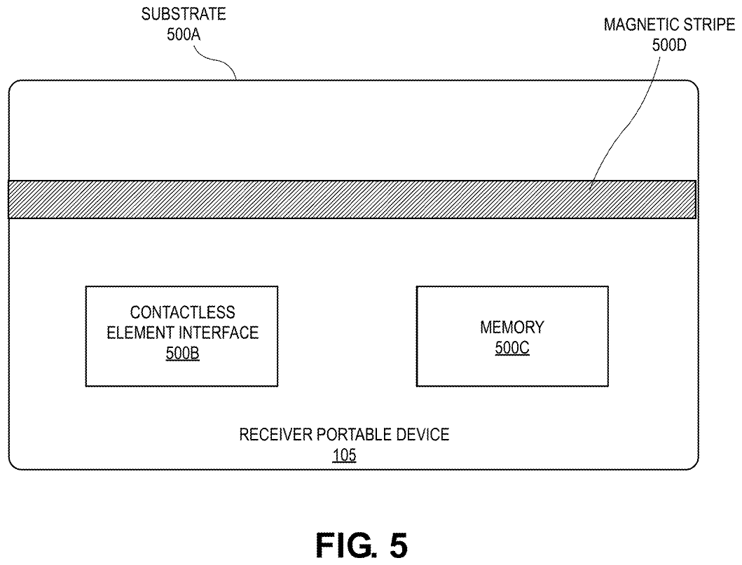

FIG. 5 shows an example portable device 105 in the form of a card. The portable device 105 comprises a substrate 500A such as a plastic substrate. A contactless element interface 500B for interfacing with a data access or data transfer device may be on or embedded within the substrate 500A. The contactless element interface 500B may include a chip and may include the capability to communicate and transfer data using near field communications (NFC) technology or other short range communications technology. The portable device 105 may be issued to a user by an authorizing entity.

The portable device 105 may also include a memory 500C, which may store user information such as an account number, expiration date, and a user name. In some cases, the memory 500C may include a secure element, and/or may also store information such as access data such as a sender credential (e.g., a sender PAN) or a receiver credential (e.g., a receiver PAN). Information in the memory 500C can be transmitted by the portable device 105 to another device such as a user device using the contactless element interface 500B. Information may also be printed or embossed on the substrate 500A. The substrate 500A may also have a magnetic stripe 500D on it.

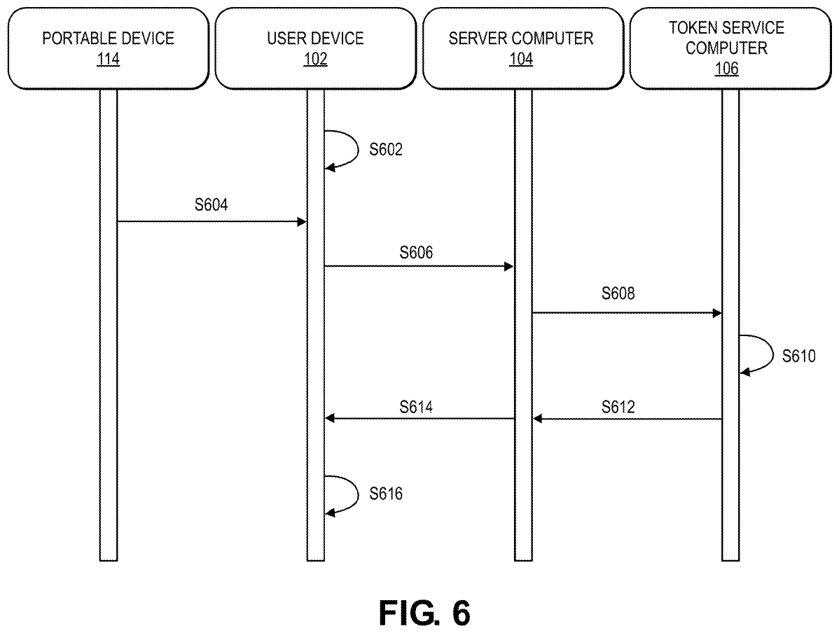

FIG. 6 shows a process flow of an initial credential tokenization process according to some embodiments. In FIG. 6, the interaction application can be a sender credential identifier and token service computer can obtain a token associated with the sender credential identifier and a sender credential. The sender token, sender credential, and sender credential identifier may be stored by the token service computer in a database. The sender credential identifier can be stored at the interaction application. As a result, when the sender user initiates an interaction at a later time, the sender user can use the stored sender credential identifier to obtain a sender token for an interaction, but not need to input the sender credential into the sender user device.

Prior to the initial credential tokenization process described below, a first authorizing entity computer can issue a sender portable device to the sender. The sender portable device can comprise a sender credential associated with the sender's account.

At step S602, a sender user can interface with an interaction application on the sender user device 102 to indicate that they would like to enroll a sender credential associated with a sender account (e.g., link an account by providing a PAN) using a sender portable device 114. The interaction application may prompt the sender user to tap the sender portable device 114 against the sender user device 102. In some embodiments, the interaction application may alternatively prompt the sender user to enter the sender credential into the sender user device 102 using a keypad or microphone. It may also prompt the sender user to provide other information such as a phone number, a name, and/or an account name into the interaction application.

At step S604, to provide the credential, the sender user (e.g. sender user 101 of FIG. 1) may interact a sender portable device 114 (not shown in FIG. 1) with sender user device 102, and the sender user device 102 can retrieve a sender user credential from the sender portable device 114. For example, the sender can tap the sender portable device 114 to the sender user device 102, thereby interacting the contactless interface of the sender portable device 114 with the contactless interface of the sender user device 102. It should be noted that the sender portable device 114 is a portable device that stores a sender credential and is therefore different from the receiver portable device 105 shown in FIG. 1.

At step S606, using the interaction application, the sender user device 102 can transmit to the server computer 104 the sender user credential. The sender user device 102 may further transmit to the server computer 104 sender user identifiers (e.g., phone number, name, account name).

At step S608, after receiving the sender user credential from the sender user device 102, the server computer 608 can transmit a tokenization request message comprising the sender credential to the token service computer 106.

At step S610, after receiving the tokenization request message comprising the sender credential, the token service computer 106 can determine a sender token and a sender credential identifier. The sender token can be obtained from a pool of pre-generated tokens or can be generated by the token service computer 106. The token service computer 106 can then store the sender token and sender credential identifier with the sender credential in a database. The sender credential identifier may be a reference to the sender user's account or sender credential that does not reveal the sender token or the sender credential. For example, if the sender credential identifier were to be obtained by a hacker, the hacker would not be able to conduct an interaction using the sender credential identifier.

At step S612, the token service computer 106 can transmit the sender credential identifier to the server computer 104.

At step S614, after receiving the sender credential identifier from the token service computer 106, the server computer 104 can transmit the sender credential identifier to the user device 102.

At step S616, after receiving the sender credential identifier from the server computer 104, the user device 102 can store the sender credential identifier. The sender credential identifier may be stored by the interaction application.

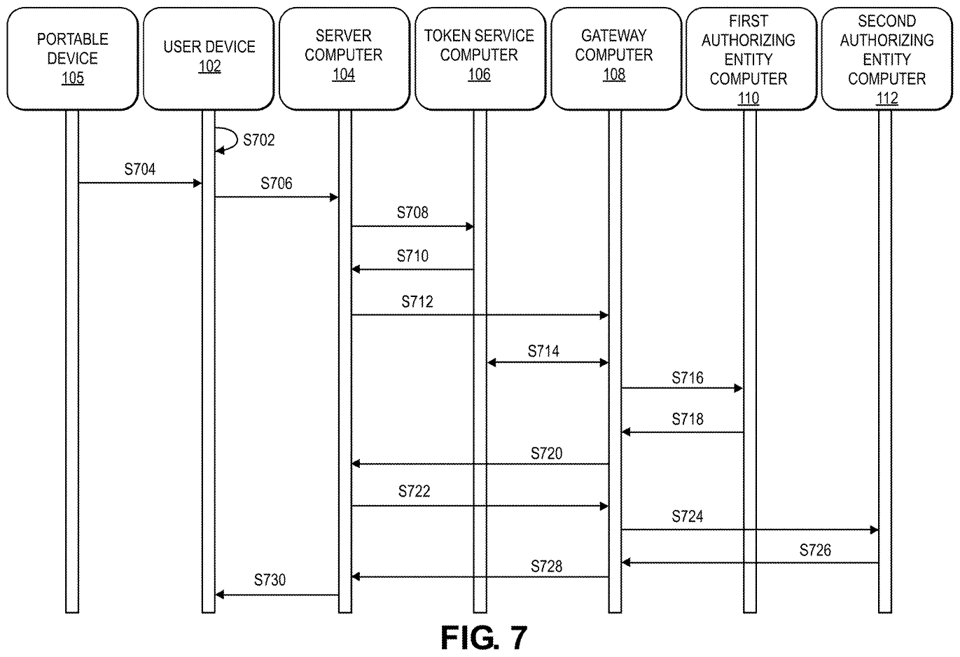

After the sender user token and sender credential identifier have been generated and stored as described in the flow above, the sender user may initiate an interaction to send funds to a receiver user according to the process flow illustrated in FIG. 7.

Prior to step S702, a first authorizing entity can register a sender user profile with the gateway computer 108 on behalf of the sender user. The sender user profile can comprise sender user identifiers and a sender user credential. The second authorizing entity may also register a receiver user profile with the gateway computer 108 on behalf of the receiver user. The receiver user profile can comprise receiver user identifiers and a receiver user credential. The gateway computer 108 can store the sender user profile and the receiver user profile.

At step S702, the sender user may indicate on the interaction application on the sender user device 102 that they wish to send funds to a receiver user. The interaction application may prompt the sender user to input interaction details into the interaction application. The interaction application may also prompt the sender user to select a sender credential identifier associated with an account which will be used to supply the funds. The sender can select the sender credential identifier from one or more credential identifiers stored in the sender user device 102. For example, the sender user may enter interaction details such as a value for the interaction and select a sender credential identifier associated with an enrolled account that they wish to use for the interaction. The interaction application may then request a receiver credential associated the account of the receiver user that will receive the funds in the interaction.

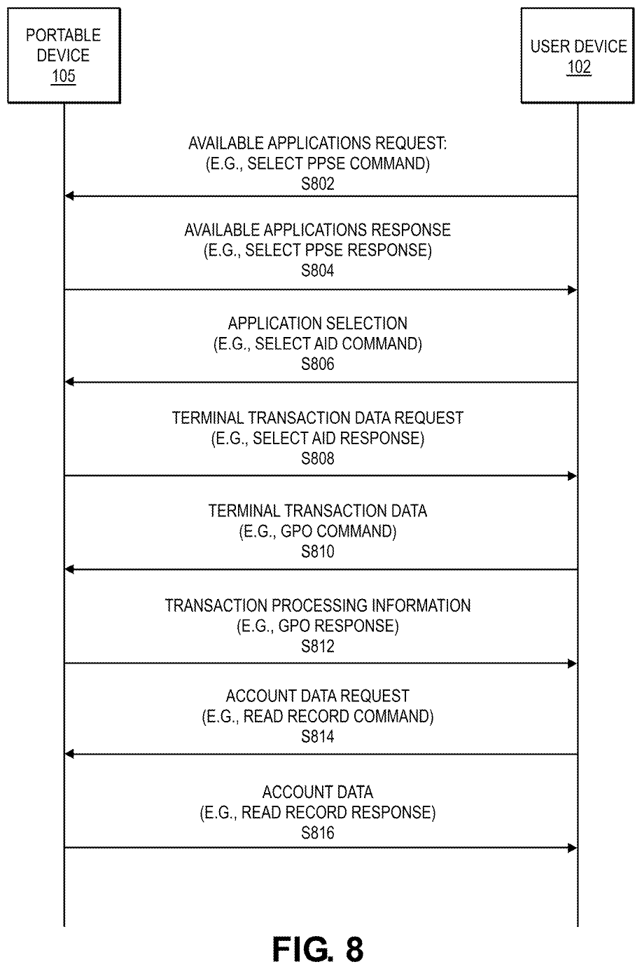

At step S704, in order to input a receiver credential, the receiver user can interact their portable device 105 with the sender user device 102, and the interaction application can obtain interaction data comprising the receiver credential. For example, the receiver user may tap the receiver portable device 105 on the sender user device 102, and the sender user device 102 may obtain a receiver credential from the payment card through contactless interaction (e.g., NFC, Bluetooth™, RFID). In some embodiments, the interaction application may also obtain other data including a cryptogram such as a CVV, CVV2, dCVV or dCVV2 value, an expiration date, etc. A process flow illustrating the interaction between the portable device 105 and the sender user device 102 is shown in FIG. 8 and is discussed below.

At step S706, after receiving the receiver credential from the portable device 105, the interaction application on the sender user device 102 can transmit to the server computer 104 an interaction request message comprising, among other information, the receiver credential, the sender credential identifier, and the value for the interaction. In some embodiments, the interaction request message may further comprise an interaction type indicator (e.g., a person to person payment). In some embodiments, prior to transmitting the interaction request message, the interaction application may request that the user authenticate themselves. For example, the user may be prompted to provide a biometric to verify that the user is the owner of the account associated with the sender credential identifier.

At step S708, after the server computer 104 receives interaction request message comprising the receiver credential, the sender credential identifier, and the value for the interaction from the interaction application on the sender user device 102, it can generate and transmit a token request message comprising at least the sender credential identifier to the token service computer 106.

The token service computer 106 can obtain (e.g., retrieve from storage) the sender token based on the sender credential identifier. It may also obtain a token cryptogram (e.g., a TAVV or transaction authentication verification value) associated with the sender token. The token cryptogram may be used to validate that the sender token is being used in an intended channel or for a particular type of interaction.

At step S710, the token service computer 106 can transmit to the server computer 104 a token response message comprising the sender token and optionally the token cryptogram.

At step S712, after receiving the sender token, the server computer 104 can transmit to gateway computer 108 the sender token, the receiver credential, the value for the interaction, and optionally the token cryptogram so that the gateway computer 108 can process the interaction. The server computer 104 can also transmit the transaction type indicator to the gateway computer 108, so that the gateway computer 108 understands how to process the received data.

In some embodiments, the server computer 104 can use API messaging (e.g., Funds Transfer API) to submit a pull interaction message comprising the sender token and the value for the interaction. The pull interaction message may further comprise interaction data such as an indication of the type of interaction (e.g., card not present, person to person).

One example of a pull interaction message may be an AFT message. An AFT (Account Funding Transaction) can be a transaction designed to supply funds to another account such as a credit, prepaid, debit, ATM card or on-line account. The AFT eventually can result in a debit to the sender's account.

At step S714, after receiving the sender token, the receiver credential, and the value for the interaction from the server computer 104, the gateway can continue to process the interaction. For example, the gateway computer 108 can format a pull interaction message (e.g., an AFT message) and transmit it to the first authorizing entity computer 110. For example, the gateway computer 108 may request that the token service computer 106 detokenize the sender token to obtain the sender credential by sending a detokenization request message comprising the sender token to the token service computer 106. Furthermore, the gateway computer 108 may determine that the sender credential is associated with the first authorizing entity computer 110. For example, once the gateway computer 108 obtains the sender credential from the token service computer 106, it can determine based on stored sender profile data that the account associated with the sender credential is managed by the first authorizing entity computer 110. In some embodiments, the gateway computer 108 may be part of a payment processing network such as VisaNet™.

At step S716 the gateway computer 108 can transmit the pull interaction message comprising the sender credential and the value for the interaction to the first authorizing entity computer 110.

At step S718, after receiving the pull interaction message comprising the sender credential and the value for the interaction, the first authorizing entity computer 110 determine whether or not the authorize the interaction. The first authorizing entity computer 110 can debit an account associated with the sender credential the value for the interaction. The first authorizing entity computer 110 can transmit to the gateway computer 108 an interaction response message indicating that the account associated with the sender has been debited.

In some embodiments, actual funds for the amount debited from the account of the sender may be transferred to a virtual account associated with the server computer 104 or the gateway computer 108.

At step S720, after receiving the interaction response message, the gateway computer 108 can transmit the interaction response message to the server computer 104.

At step S722 after receiving the interaction response message, if the interaction response message indicated that the interaction was approved by the first authorizing entity computer 110, the server computer 104 may also use API messaging to submit a push interaction message (e.g., an OCT message) comprising the receiver credential and the value for the interaction to the gateway computer 108.

An example of a push interaction message may be an OCT (Original Credit Transaction) message. When used in the context of money transfer from a sender user to a receiver user, the OCT is the transaction used to deliver funds to the receiver account. A special indicator identifies an OCT to the second authorizing entity computer 112 associated with the receiver user. It is separate from, and takes place after, the AFT. This timing is to ensure that the value for the interaction is secured before value is sent to the recipient.

At step S724 after receiving the push interaction message from the server computer 104, the gateway computer 108 can transmit an interaction request message comprising the receiver credential and the value for the interaction to the second authorizing entity computer 112. For example, the gateway computer 108 can determine based on stored receiver profile data that the account associated with the receiver credential is managed by the second authorizing entity computer 112.

At step S726, using the receiver credential, the second authorizing entity computer 112 can determine whether or not to authorize the interaction and transmit an interaction response message comprising the determination to the gateway computer 108. If the second authorizing entity computer 112 authorizes the interaction, the second authorizing entity computer 112 can credit an account associated with the receiver credential the value for the interaction. The second authorizing entity computer 112 can transmit to the gateway computer 108, an interaction response message indicating that the account associated with the receiver has been credited.

At step S728 after receiving the interaction response message from the second authorizing entity computer 112, the gateway computer 108 can transmit the interaction response message to the server computer 104.

In step S730, the server computer 104 can transmit the interaction response message(s) to the sender user device 102 to inform the sender user of the result of the interaction. The server computer 104 or the second authorizing entity computer 112 can also send a notification message to the receiver user (e.g., send notification to receiver user device that account was credited).

In some embodiments, funds that pulled from the sender's account into the virtual account managed by the server computer 104 or the gateway computer 108 can be sent from the virtual account to the account of the receiver user at the second authorizing entity computer 112.

In other embodiments, after the push and pull interaction messages have been processed, a later time, clearing and settlement processes can take place between the gateway computer 108, the first authorizing entity computer 110, and the second authorizing entity computer 112.

FIG. 8 illustrates an example communication flow between a portable device 105 and a user device 102 according to some embodiments. The steps in FIG. 8 can occur in step 2 in the flow described above with respect to FIG. 3.

User device 102 can be emulated, for example, based on an access device profile such as an actual point of sale (POS) terminal. The communications between the user device 102 and the portable device 105 can be in the form of application commands sent from user device 102 and application data responses sent from portable device 105 in response to the application commands. In some embodiments, the application commands and data responses can be in the form of APDU commands and responses. However, it should be understood that other messages, messaging protocols, or formats can be used to exchange the application data to conduct the transaction.

To initiate the application data exchange, user device 102 may initiate a transaction by sending an available applications request S802 to portable device 105 to request information as to which payment application identifier(s) (AID(s)) may be available. Each AID may correspond to an account of the user and/or processing options associated with an account. In some embodiments, the available application(s) request S802 may be in the form of a select PPSE command. The available applications request S802 may include a payment environment identifier (e.g., a PPSE name) to identify the payment environment supported by user device 102.

Upon receiving the available applications request S802, portable device 105 may identify and process the request by recognizing the payment environment identifier (e.g., PPSE name) included in the request, and respond by sending an available applications response S804 back to user device 102. The available applications response S804 may include a list of available AIDs, and may include the payment environment identifier (e.g., PPSE name) as the dedicated file name. In some embodiments, the available applications response S804 may be in the form of a select PPSE response and may include PPSE file control information (FCI). For example, the available applications response S804 may include a directory entry for each available AID. If portable device 105 supports only one AID, portable device 105 may respond with a single directory entry for the supported AID. If portable device 105 supports an account with multiple AIDs, the transaction application may respond with a directory entry for each of the supported AIDs. Each directory entry may include information such as the AID, an application label associated with the AID (e.g., a mnemonic associated with the AID), an application priority indicator indicating the priority of the AID, a kernel identifier indicating the application's kernel preference, and/or additional information relating to the particular AID. The available application(s) response S804 may also include other data such as FCI issuer discretionary data.

When user device 102 receives the available applications response S804, user device 102 may select a suitable application from the list of applications received in the available applications response S804 (e.g., by selecting an AID from the available AID(s) received in the available application(s) response S804). In some embodiments, the selected AID can be the highest priority AID on a prioritized list of application identifiers supported by the access device being emulated by user device 102. The prioritized list of application identifiers can be obtained as part of the access device profile. User device 102 may send an application selection S806 with the selected AID to portable device 105 to continue the transaction. In some embodiments, the application selection S806 can be in the form of a select AID command.

Upon receiving the application selection, portable device 105 may send a terminal transaction data request S808 to request transaction data from user device 102 to execute the transaction using the selected application/AID. In some embodiments, the terminal transaction data request S808 may be in the form of a select AID response and may include AID file control information (FCI) with the selected AID as the dedicated file name. The terminal transaction data request S808 may include a list of transaction data identifiers to request the appropriate data from user device 102, and the list of transaction data identifiers can be in the form of a processing options data object list (PDOL). The transaction data requested by portable device 105 for the transaction may include terminal transaction qualifiers (TTQ), authorized amount, other amount, terminal country code, terminal verification results, transaction currency code, transaction data, transaction type, and/or an unpredictable number. The terminal transaction data request S808 may also include other data such as FCI issuer discretionary data, application program identifier, and language preference.

After receiving the terminal transaction data request S808, the user device 102 may send to the portable device 105, the terminal transaction data S810 requested by portable device 105. The terminal transaction data S810 provided by user device 102 can be obtained from the previously described resource provider application. In some embodiments, the terminal transaction data S810 may be sent in the form of a get processing options (GPO) command, and may include the requested terminal transaction data in a processing options data object list (PDOL). In some embodiments, the terminal transaction data S810 (e.g., terminal transaction qualifiers (TTQ)) may include a transaction type indicator indicating the type of transaction supported by the access device. In some embodiments, the terminal transaction data S810 (e.g., terminal transaction qualifiers (TTQ)) may also include a consumer verification method (CVM) requirement indicator to indicate whether a CVM is required by the access device for the transaction, and also one or more CVM type indicators indicating the types of CVM supported by the access device. Examples of CVMs that may be supported by the access device can include online PIN, signature, and/or consumer device CVM (CDCVM) such as a passcode to unlock the screen or portable device 105.

Once the portable device 105 receives terminal transaction data S810, portable device 105 may increment its Application Transaction Counter (ATC), generate dynamic transaction processing information using at least some of the received terminal transaction data S810, and send a set of transaction processing information S812 including the generated dynamic transaction processing information to user device 102. In some embodiments, the transaction processing information S812 can be sent in the form of a GPO response. In some embodiments, the transaction processing information S812 may include one or more application file locators (AFLs) that can be used as file address(es) by user device 102 to read account data stored on portable device 105, and an application interchange profile (AIP) that can be used to indicate the capabilities of portable device 105.

In some embodiments, the AFLs included in transaction processing information S812 may include file addresses to read account data such as a transaction cryptogram dynamically generated using a limited-use key (LUK) and/or unpredictable number from the access device, track-2 equivalent data including a token or a PAN, and addition data such as issuer application data (IAD), form factor indicator (FFI), card transaction qualifiers (CTQ), cryptogram information data (CID), the updated ATC, and/or an application PAN sequence number (PSN). In some embodiments, the issuer application data (IAD) may include a length indicator indicating the length of the IAD, cryptogram version number (CVN) indicating the version of the transaction cryptogram, a derived key indicator (DKI) that can be used to identify a master key (e.g. a master key associated with the issuer used in generation of the LUK), card verification results (CVR), a wallet provider ID, and/or derivation data such as the key index that was used in the generation of the LUK. In some embodiments, transaction processing information S812 may include the above account data themselves instead of their corresponding AFLs, or a combination thereof. It should also be understood that in some embodiments, the transaction processing information S812 being sent from portable device 105 to user device 102 may include some or all of the information describe above, and in some embodiments, may include additional information not specifically described.

After user device 102 receives the transaction processing information S812, user device 102 may send an account data request S814 to portable device 105 to read additional account data that may be stored on the portable device 105. In some embodiments, the account data request S814 may be in the form of a read record command, and may include an application file locator (AFL) indicating the location of the account data that user device 102 is attempting to read. The AFL included in the account data request S814 may correspond to an AFL in the transaction processing information S812 that was provided to user device 102 from portable device 105.

In response to receiving the account data request S814 from user device 102, portable device 105 may send the account data S816 stored at the location indicated by the AFL to user device 102. In some embodiments, the account data S816 may be sent in the form of a read record response. The account data S816 may include, for example, the account data elements discussed above (e.g., a PAN, token, CVV, etc.), and/or application usage control that indicates the issuer's restrictions on the usage and services allowed for the application, the cardholder's name, customer exclusive data, issuer country code, token requester ID (e.g., if a token is used), and/or other account related data that is accessible at the AFL location. It should be understood that in some embodiments, the account data S816 being sent from portable device 105 to user device 102 may include some or all of the information describe above, and in some embodiments, may include additional information not specifically described.

Once user device 102 has received the requisite data from the transaction processing information S812 and/or one or more account data S816 transmissions, some or all of the data elements in the transaction processing information S812 and/or one or more account data S816 transmissions can be concatenated (or not) by user device 102 to form a data packet. The data packet may include a checksum and a packet length indicator to indicate the length of the data packet. The data packet can be used by a processing module (e.g., in a remote computer or in the user device 102) to generate a transaction authorization request message to request authorization of the transaction from the issuer. For example, in some embodiments, the transaction authorization request message may include at least the track-2 equivalent data including a token or PAN, and the transaction cryptogram generated with the LUK, and the transaction can be authorized based on at least verifying that the transaction cryptogram was generated correctly and that the LUK used in generation of the transaction cryptogram has not exhausted the LUK's set of one or more limited use thresholds.

Embodiments of the invention have a number of advantages. For example, embodiments of the invention can protect the account information of a sender user by tokenizing the sender credential to form a sender token, and then providing a sender credential identifier for the account information to the sender's user device. The sender credential identifier for the account information can be used by a sender user device to access the sender token, which is used to initiate an interaction. The use of the sender credential identifier and the sender token can protect the sender credential from man-in-the-middle attacks or hacking. Further in embodiments of the invention, the sender user does not need to manually input the sender credential in order to initiate an interaction, and can instead select the stored sender credential identifier. Further, embodiments of the invention are more convenient than conventional systems since a receiver user wishing to receive funds from a first user can simply tap or interact their payment device with a user device of the sender user. As an advantage, the receiver user does not need to present their own user device, nor do they need to have an interaction application downloaded to their own user device.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer from an interaction application on a sender user device, an interaction request message comprising a sender credential identifier, a receiver credential and a value for an interaction between a sender operating the sender user device and a receiver, the receiver credential associated with the receiver and received by the interaction application after the receiver interacts a portable device comprising the receiver credential with the sender user device;
transmitting, by the server computer to a token service computer, a token request message comprising the sender credential identifier;
receiving, by the server computer from the token service computer, a token response message comprising a sender token; and
transmitting, by the server computer to a gateway computer, the sender token, the receiver credential, and the value,
wherein the gateway computer processes the interaction using the value, the receiver credential, and the sender token.

2. The method of claim 1, wherein the method further comprises, prior to receiving the interaction request message:
receiving, by the server computer from the interaction application on the sender user device, the sender credential associated with the sender and received by the interaction application after the sender interacts a sender portable device comprising the sender credential with the sender user device;
transmitting, by the server computer to the token service computer, a tokenization request message comprising the sender credential, wherein the token service computer tokenizes the sender credential to form the sender token, generates the sender credential identifier, and stores the sender token, the sender credential, and the sender credential identifier in a database;
receiving, by the server computer from the token service computer, the sender credential identifier; and
transmitting, by the server computer, the sender credential identifier to the sender user device, wherein the sender user device stores the sender credential identifier.

3. The method of claim 2, further comprising:
receiving, by the server computer from the gateway computer, an interaction response message; and
transmitting, by the server computer to the interaction application on the sender user device, the interaction response message.

4. The method of claim 3, further comprising:
prior to receiving the interaction request message, receiving, by the gateway computer from a first authorizing entity computer, a sender user profile comprising the sender credential; and
receiving, by the gateway computer from a second authorizing entity computer, a receiver user profile comprising the receiver credential.

5. The method of claim 4, wherein the gateway computer processes the interaction by:
transmitting, by the gateway computer to the token service computer, a detokenization request message comprising the sender token;
obtaining, by the gateway computer from the token service computer, the sender credential;
transmitting, by the gateway computer to the first authorizing entity computer, a pull interaction message comprising the sender credential; and
transmitting, by the gateway computer to the second authorizing entity computer, a push interaction message comprising the receiver credential.

6. The method of claim 5, wherein the first authorizing entity computer manages an account associated with the sender credential on behalf of the sender and the second authorizing entity computer manages an account associated with the receiver credential on behalf of the receiver.

7. The method of claim 1, wherein the gateway computer processes the interaction by transmitting a pull interaction message to a first authorizing entity computer and then transmitting a push interaction message comprising the receiver credential to a second authorizing entity computer.

8. The method of claim 7, wherein the push interaction message further comprises the value for the interaction, and the pull interaction message further comprises the value for the interaction.

9. The method of claim 1, wherein the receiver credential is obtained using a contactless interaction.

10. The method of claim 1, wherein the interaction is an access interaction.

11. The method of claim 1, wherein the server computer is associated with the interaction application.

12. The method of claim 1, wherein the interaction request message is sent after the sender authenticates to the sender user device.

13. The method of claim 1, wherein the sender user device is a mobile phone and the portable device is in the form of a card.

14. The method of claim 1, wherein the value for the interaction is input into the interaction application by the sender.

15. A server computer comprising:
a processor; and
a computer readable medium comprising code, executable by the processor for implementing a method comprising:
receiving, from an interaction application on a sender user device, an interaction request message comprising a sender credential identifier, a receiver credential and a value for an interaction between a sender operating the sender user device and a receiver, the receiver credential associated with the receiver and received by the interaction application after the receiver interacts a portable device comprising the receiver credential with the sender user device;
transmitting, to a token service computer, a token request message comprising the sender credential identifier;
receiving, from the token service computer, a token response message comprising a sender token; and
transmitting, to a gateway computer, the sender token, the receiver credential, and the value,
wherein the gateway computer processes the interaction using the value, the receiver credential, and the sender token.

16. The server computer of claim 15, the method further comprising:
prior to receiving the interaction request message, receiving, by the server computer from the interaction application on the sender user device, the sender credential associated with the sender and received by the interaction application after the sender interacts a sender portable device comprising the sender credential with the sender user device;
transmitting, by the server computer to the token service computer, a tokenization request message comprising the sender credential, wherein the token service computer tokenizes the sender credential to form the sender token, generates the sender credential identifier, and stores the sender token, the sender credential, and the sender credential identifier in a database;
receiving, by the server computer from the token service computer, the sender credential identifier; and
transmitting, by the server computer, the sender credential identifier to the sender user device, wherein the sender user device stores the sender credential identifier.

17. A method comprising:
interacting, a portable device comprising a receiver credential with a sender user device in an interaction between a sender operating the sender user device and a receiver, the receiver credential associated with the receiver;
transmitting, by an interaction application on the sender user device to a server computer, an interaction request message comprising the receiver credential, a sender credential identifier, and a value for the interaction, wherein the server computer transmits a token request message comprising the sender credential identifier to a token service computer and receives from the token service computer, a token response message comprising a sender token, and transmits the sender token, the receiver credential, and the value to a gateway computer, wherein the gateway computer processes the interaction using the sender token, the receiver credential, and the value; and
receiving, by the sender user device an interaction response message from the server computer for the interaction.

18. The method of claim 17, further comprising, prior to interacting the portable device comprising the receiver credential with the sender user device:
interacting a sender portable device comprising a sender credential with the sender user device;
transmitting, by the interaction application on the sender user device to the server computer, the sender credential, wherein the server computer transmits a tokenization request message to the token service computer comprising the sender credential, and wherein the token service computer determines the sender credential identifier and the sender token, stores the sender credential identifier and the sender token with the sender credential, and transmits to the sender user device via the server computer the sender credential identifier; and
storing, by the sender user device, the sender credential identifier.

19. The method of claim 18, wherein the gateway computer processes the interaction by transmitting a pull interaction message to a first authorizing entity computer and then transmitting a push interaction message comprising the receiver credential to a second authorizing entity computer.

20. The method of claim 17, wherein the sender user device is a mobile phone with a contactless interface.
